(19) United States
(12) Patent Application Publication
(10) Pub. No.: US 2018/0050760 A1
(43) Pub. Date: Feb. 22, 2018

(54) MID-MOUNT MOTOR ASSEMBLY APPARATUS AND METHOD OF USE

(71) Applicant: Bruce Ponder, Albuquerque, NM (US)

(72) Inventor: Bruce Ponder, Albuquerque, NM (US)

(21) Appl. No.: 15/239,798

(22) Filed: Aug. 17, 2016

(51) Int. Cl. B62M 6/00; B62D 65/10

(52) U.S. Cl. CPC B62M 6/00; B62M 6/55; B62D 65/10

(57) ABSTRACT

The present invention relates generally to motorizing a bicycle, and more particularly to an assembly for a quick-release mid-mount motor assembly system. The present invention comprises a bicycle motor assembly system comprising: a bottom bracket; an upper bracket; an engine disposed on upper bracket; and a freewheel system. The present invention also comprises a method of installing a bicycle motor assembly system comprising: providing a bottom bracket; providing an upper bracket; providing an engine disposed on upper bracket; providing a freewheel system; and securably disposing upper bracket in bottom bracket. The bicycle motor assembly system provides an easily installed motor that allows for the bicycle to either be pedaled or motored.

### CROSS-REFERENCE TO RELATED APPLICATION

This application claims the benefit of U.S. Provisional Patent Application Ser. No. 62/206,144 filed Aug. 17, 2015, titled “Mid-Mount Motor Assembly Apparatus and Method of Use” and the subject matter thereof is incorporated herein by reference thereto.

### TECHNICAL FIELD

The present invention relates generally to motorizing a bicycle, and more particularly to an assembly for a quick-release mid-mount motor assembly system.

### BACKGROUND ART

Bicycles are useful modes of transportation, but motorizing them provides certain inadequacies. If riders want to add a motor to their bicycle, they typically have to either buy a motorized bicycle or have a motor professionally and permanently installed. Once the motor is installed, the bicycle can typically only be powered by the motor. Thus, if the motor breaks or power source is compromised, the rider is unable to ride the bicycle until the motor is repaired, refueled, or recharged. The market has not yet provided an easy-to-install, mid-mount motor for bicycles that also allows the bicycle to be either pedaled or motored without any adjustments, or to be alternatively assisted by, including, but not limited to, a gas, electric, or propane motor interchangeably without the use of tools.

The present invention comprises a mid-mount motor assembly system that is an improvement on the motorized bicycle assemblies currently available. The present invention allows the rider to either pedal or use the motor at any time while riding without have to make any modifications or changes. The present invention also provides a quick-release mid-mount motor assembly system that is able to be retro-fitted to already-produced bicycle and to interchange motors as desired and without the use of tools.

Many devices are known in the prior art aimed at motorizing bicycles. U.S. Pat. No. 7,568,714B2 entitled “Bicycle Having a Removable Power Assist Module” provides a bicycle with a removable power assist module. The assembly of the prior art requires a specially-made bicycle and cannot be retro-fitted on already-produced bicycles.

U.S. Pat. No. 3,978,936 entitled “Bicycle Drive Means” provides a motor pivotably mounted on the front fork of a bicycle.

U.S. Pat. No. 677,830 entitled “Bicycle Frame” provides a motor permanently mounted to the bicycle frame.

There are no well-designed, simple devices currently available that easily allow a motor to be added to an existing bicycle. Currently available bicycle motor assemblies are either permanently affixed to bicycles, do not allow for pedaling, or are ill-fitting retrofit additions resulting in bicyclists having to choose between having a motor and not having a motor. Currently, the motor and bicycle are typically bundled together and difficult, if not impossible, to separate. If the battery or power source is interrupted, the rider must also carry the weight of the motor system. Any repairs to the bicycle encompass an attached motor and therefore must be made to the bicycle and motor as a combined system and not solely to the bicycle or the motor portion separately. Thus, there is a need for a quick-release mid-mount motor assembly system that is able to retro-fit already-produced bicycles that allows the bicycle to be either pedaled or motored without any adjustments.

It is increasingly critical that answers be found to the challenges arising from inadequate bicycle motor system designs due to the increase in bicycling commuting. Additionally, the need to reduce costs, improve efficiencies and performance, and meet competitive pressures adds an even greater urgency to creating new bicycle motor system products that meet the needs of a diverse community of bicyclists.

The present invention provides an apparatus for and method of motorizing a bicycle that are an improvement on bicycle motor systems and devices presently available. The present invention provides for a bicycle motor system that is easily mounted on and removed from any bicycle, can be retro-fitted to existing bicycles, and allows the bicycle to be either pedaled or motored without any adjustments. The present invention overcomes the limitations and difficulties described previously with respect to bicycle motor systems currently available by providing a quick-release mid-mount motor assembly system that is able to retro-fit already-produced bicycles that allows the bicycle to be either pedaled or motored without any adjustments.

An advantage of the apparatus of the present invention is that it is fitted to any bicycle at the strongest and most universally similarly sized attachment point which is the bottom bracket and crankset spindle. Another advantage of the present invention is it allows a motor to be easily removed and for battery/fuel and motor weight to be removable, centered, and low. Yet another advantage of the present invention is it allows the bicycle to be either pedaled or motored without any adjustments and for a plurality of motors to be used interchangeably as either power assist or the sole source of power. The resulting device is straightforward, cost-effective, uncomplicated, highly versatile, and effective, and is implemented by adapting known components for ready, efficient, and economical manufacturing, application, and utilization. Yet another advantage of the present invention is that the motor can be installed and removed without tools via a semi-permanent docking system connecting the bicycle and mounts that once installed with tools, allows a plurality of motor to become quick-disconnect and then attached or detached without tools.

Certain embodiments of the invention have other steps or elements in addition to or in place of those mentioned above. The steps or element will become apparent to those skilled in the art from a reading of the following detailed description when taken with reference to the accompanying figures.

### SUMMARY OF THE INVENTION

The present invention comprises a bicycle motor assembly system comprising: a bottom bracket; an upper bracket; an engine disposed on upper bracket; and a freewheel system.

The present invention also comprises a method of installing a bicycle motor assembly system comprising: providing a bottom bracket; providing an upper bracket; providing an engine disposed on upper bracket; providing a freewheel system; and securably disposing upper bracket in bottom bracket.

### BRIEF DESCRIPTION OF THE DRAWINGS

FIG. 1 illustrates a perspective view of the pieces comprising a first embodiment of the mid-mount bicycle engine assembly of the present invention;

FIG. 2 illustrates a perspective view of the mid-mount engine mount of the present invention with an engine attached;

FIG. 3 illustrates a perspective view of the mid-mount bicycle engine assembly of the present invention installed on a bicycle with an engine;

FIG. 4 illustrates a perspective view of the mid-mount bicycle engine assembly of the present invention installed on a bicycle without an engine;

FIG. 5 illustrates a perspective view of the pieces comprising an alternate embodiment of the mid-mount bicycle engine assembly of the present invention;

FIG. 6 illustrates a perspective view of the mid-mount bicycle engine assembly of the present invention installed on a bicycle; and

FIG. 7 illustrates a perspective view of the freewheel system of the present invention installed on a bicycle.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known system configurations, and process steps are not disclosed in detail.

The figures illustrating embodiments of the system are semi-diagrammatic and not to scale and, particularly, some of the dimensions are for the clarity of presentation and are shown exaggerated in the drawing figures.

The same numbers are used in all the drawing figures to relate to the same elements. The embodiments have been numbered first embodiment, second embodiment, etc. as a matter of descriptive convenience and are not intended to have any other significance or provide limitations for the present invention.

For expository purposes, the term “horizontal” as used herein is defined as a plane parallel to the plane or surface of the bicycle rack system, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures. The term “on” means that there is direct contact among elements.

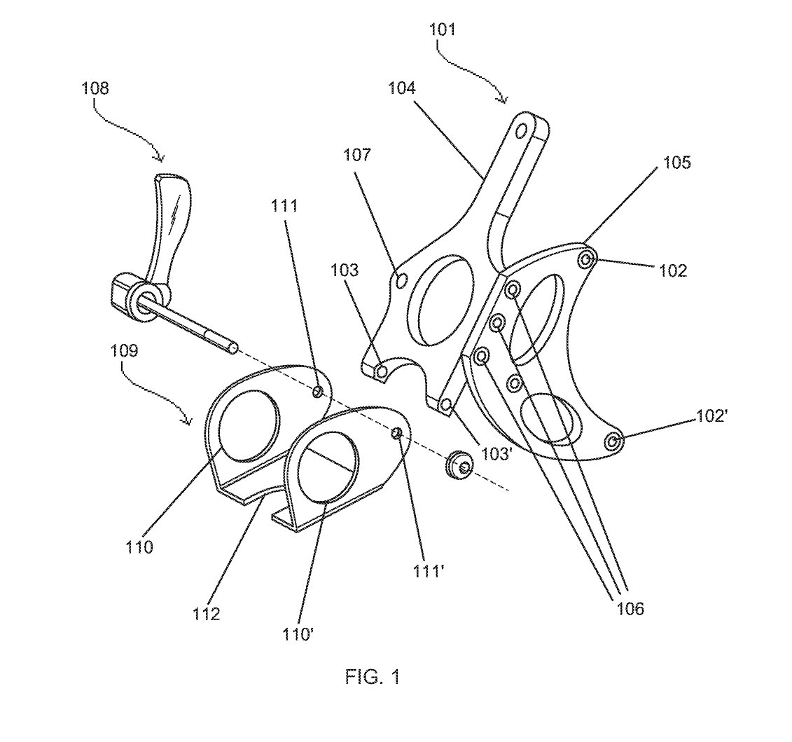

FIG. 1 illustrates a perspective view of engine mount 101, bicycle racket mount 109, and pin 108 that comprise a first embodiment of the mid-mount bicycle engine assembly of the present invention. Engine mount 101 comprises engine mount engine connection piece 105 and engine mount bicycle connection piece 104, connected via a plurality of engine mount connectors 106. A plurality of engine mount connection points 102 and 102′ are disposed on engine mount engine connection piece 105 which are used to connect the engine to the engine mount 101. A plurality of additional engine connections 107 are disposed on engine mount 101.

Bicycle racket mount 109 comprises bicycle bracket mount pedal holes 110 and 110′ and bicycle bracket mount frame hole 112. Bicycle racket mount 109 connects to engine mount 101 via pin 108 inserted through engine mount holes 103 and 103′ and bicycle bracket mount holes 111 and 111′.

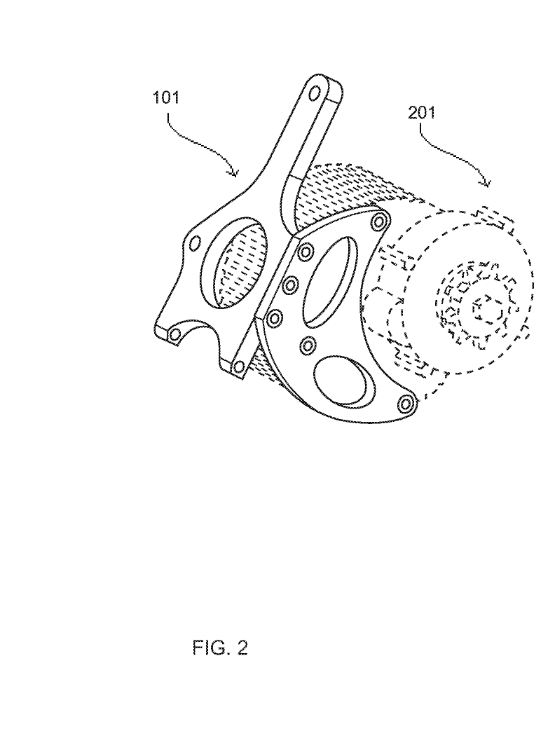

FIG. 2 illustrates a perspective view of the engine mount 101 of the present invention with engine 201 attached to engine mount 101.

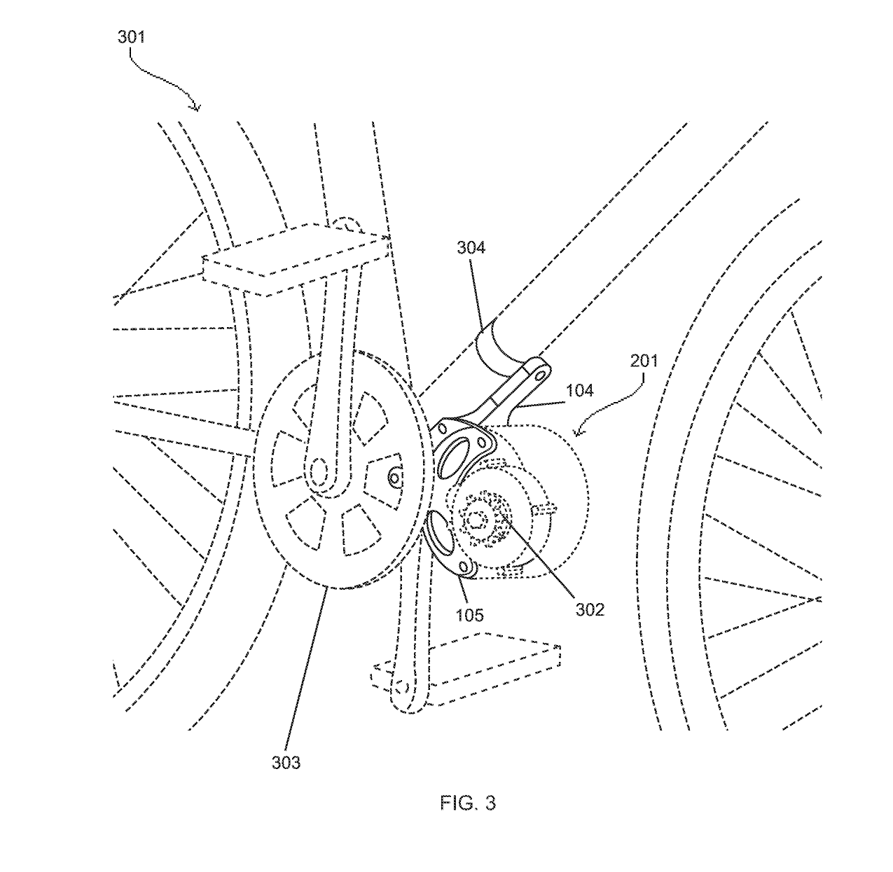

FIG. 3 illustrates a perspective view of the mid-mount bicycle engine assembly of the present invention installed on bicycle 301 with engine 201. Engine mount upper connector 304 secures engine mount bicycle connection piece 104 to bicycle 301. Engine 201 is secured to engine mount engine connection piece 105. A bicycle chain (not pictured) attaches freewheel 303 to engine chain connector 302 allowing engine 201 to power bicycle 301.

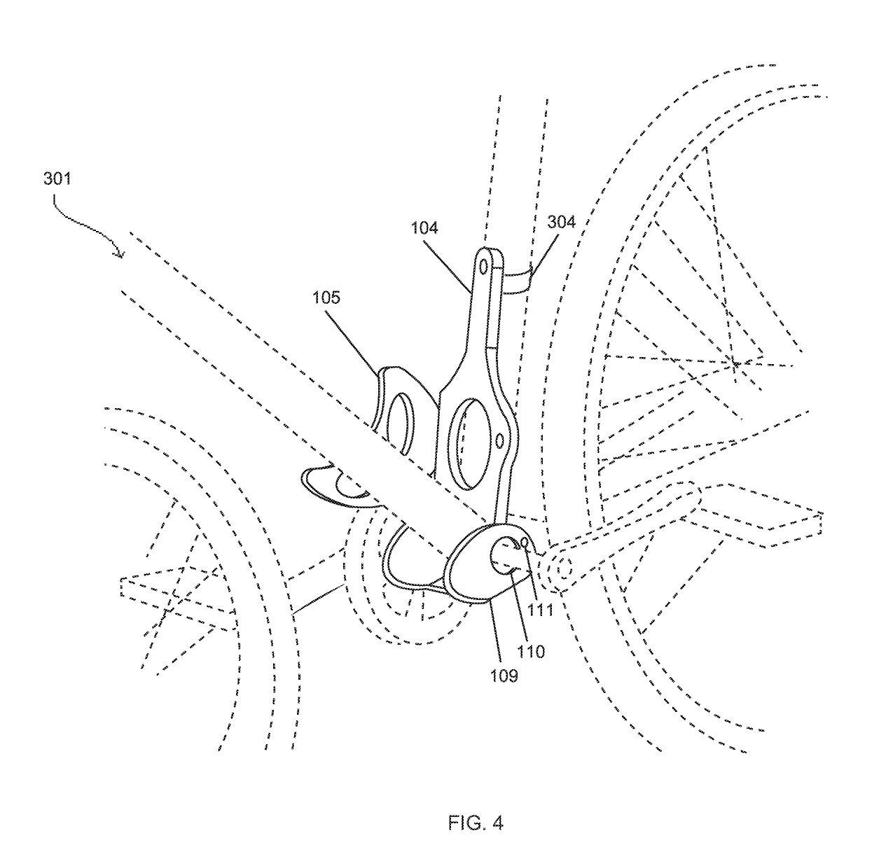

FIG. 4 illustrates a perspective view of the mid-mount bicycle engine assembly of the present invention installed on bicycle 301 without an engine. Bicycle racket mount 109 comprises bicycle bracket mount pedal holes 110 and 110′. The pedal crankset of bicycle 301 are inserted through bicycle bracket mount pedal holes 110 and 110′, securing bicycle racket mount 109 to bicycle 301. Engine mount upper connector 304 further secures engine mount bicycle connection piece 104 to bicycle 301.

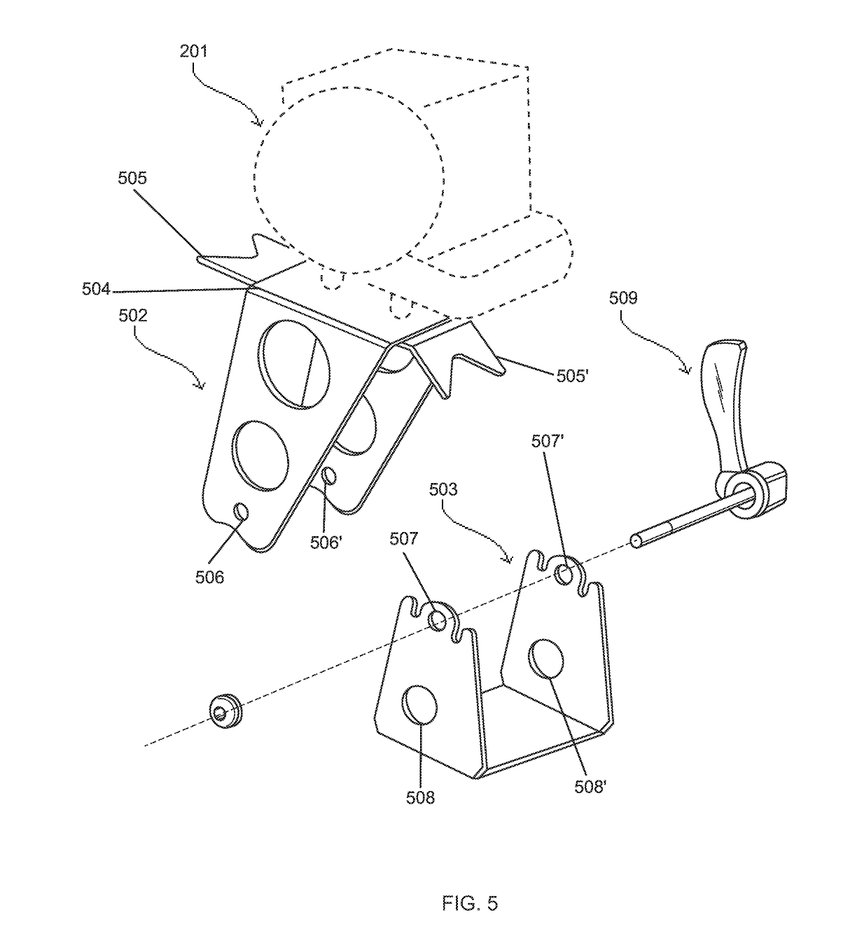

FIG. 5 illustrates a perspective view of upper engine mount 502, upper bicycle bracket mount 503, and upper pin 509 that comprise an alternate embodiment of the mid-mount bicycle engine assembly of the present invention. Engine 201 is disposed on upper engine mount platform 504. Upper engine mount bicycle connectors 505 and 505′ fit snugly against the bicycle frame once the mid-mount bicycle engine assembly of the present invention is installed. Upper engine mount 502 connects to upper bicycle bracket mount 503 via upper pin 509 inserted through upper engine bracket mount holes 506 and 506′ and upper bicycle bracket mount holes 507 and 507′. Upper bicycle bracket mount 503 further comprises upper bicycle bracket mount pedal holes 508 and 508′.

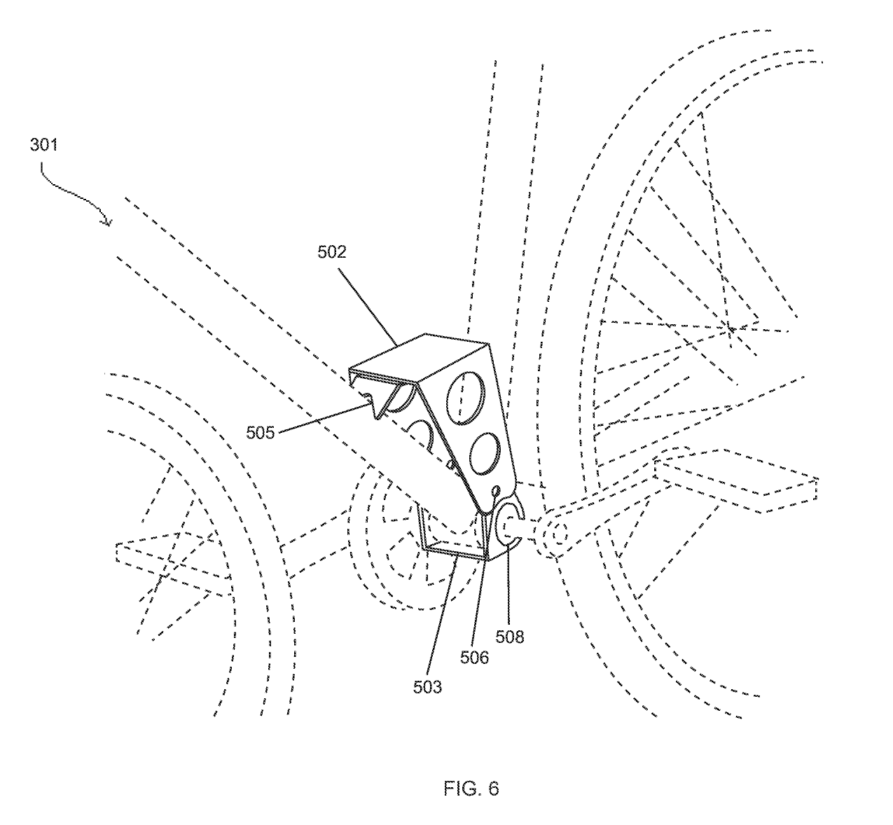

FIG. 6 illustrates a perspective view of the mid-mount bicycle engine assembly of the present invention installed on bicycle 301. The pedal crankset of bicycle 301 are inserted through upper bicycle bracket mount pedal holes 508 and 508′, securing upper bicycle bracket mount 503 to bicycle 301. Upper engine mount bicycle connectors 505 and 505′ fit snugly against the bicycle frame once the mid-mount bicycle engine assembly of the present invention is installed, thus further securing upper engine mount 502 to bicycle 301. Upper engine mount 502 connects to upper bicycle bracket mount 503 via upper pin 509 inserted through upper engine bracket mount holes 506 and 506′ and upper bicycle bracket mount holes 507 and 507′.

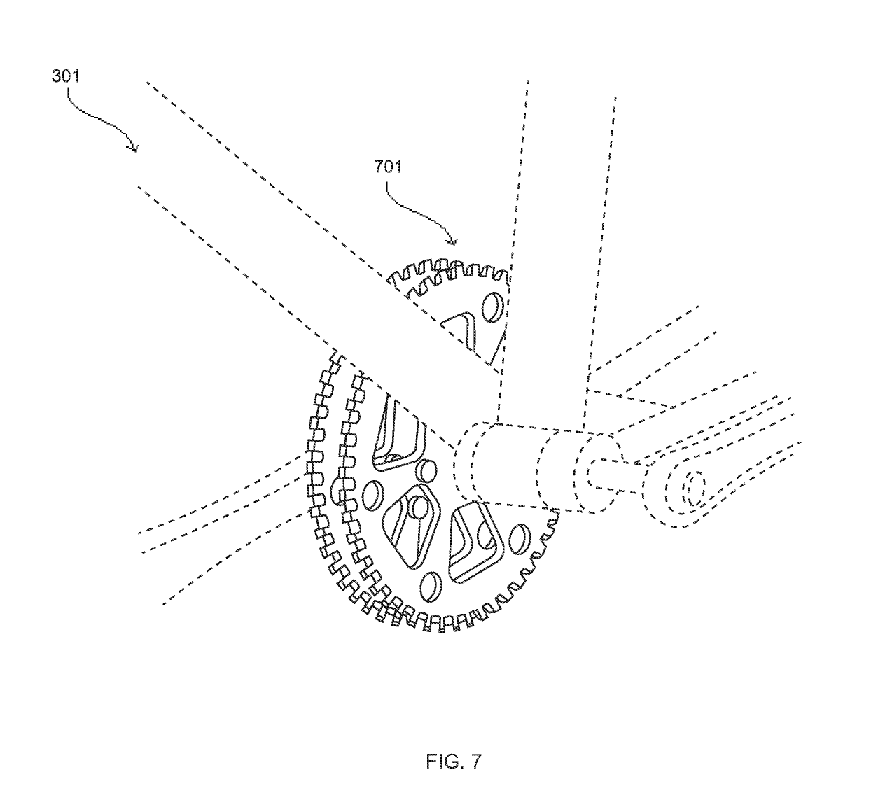

FIG. 7 illustrates a perspective view of the freewheel system of the present invention installed on bicycle 301. Freewheel 701 allows for a plurality of chains or belts, or other similar equipment, to be attached at once. For example, one to the rear derailleur, which is controlled by the pedal crankset, and one to the motor. These chains operate independently. Once the motor is installed, freewheel 701 allows the bicycle to be either motorized or pedaled at any given time without any switching involved. This also allows for the pedals to be stationary when the motor is being used. Once the motor is installed, a chain or belt is installed on the freewheel system. A rider can also pedal while also utilizing the engine.

The method of securing the mid-mount bicycle motor assembly of the present invention to a bicycle comprises the following. Bicycle racket mount 109 or upper bicycle bracket mount 503 is attached to the bicycle frame. Once attached, engine mount 101 or upper engine mount 502, of which the motor 201 is attached to, is disposed in bicycle racket mount 109 or upper bicycle bracket mount 503 and secured by pin 108 or upper pin 509 or other means. As part of the mid-mount bicycle motor assembly, freewheel 701 may or may not be installed on the bicycle. When installed, freewheel 701 allows for a plurality of chains or belts, or other equipment, to be attached at once: one to the rear derailleur, which is controlled by the pedal crankset, and one to the motor. Once the motor is installed, a chain or belt in installed on the 701 attached to the motor. A second chain or belt attaches freewheel 701 to the rear derailleur. Freewheel 701 allows the bicycle to be either motorized or pedaled at any given time without any switching involved. This also allows for the pedals to be stationary when the motor is being used.

In an alternate embodiment, freewheel 701 is not used. Instead, the existing chain on the bicycle is disposed on the motor.

The present invention can be used to mount any type of motor, including gas or electric.

Another flexible aspect of mid-mount bicycle motor assembly of the present invention is the ability for a motor to easily be taken on and off of a bicycle. Bicycle racket mount 109 or upper bicycle bracket mount 503 are permanently installed on any bicycle and offer a platform for engine mount 101 or upper engine mount 502, of which the motor 201 is attached to, to easily be attached.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying drawings are to be interpreted in an illustrative and non-limiting sense.

What is claimed is:

1. A bicycle motor assembly system comprising:
a bottom bracket;
an upper bracket;
an engine disposed on upper bracket; and
a freewheel system.

2. A method of installing a bicycle motor assembly system comprising:
providing a bottom bracket;
providing an upper bracket;
providing an engine disposed on upper bracket;
providing a freewheel system;
securably attaching bottom bracket to a bicycle;
securably disposing upper bracket in bottom bracket; and
securably attaching engine to freewheel via chain or belt.
